(19) United States
(12) Patent Application Publication
(10) Pub. No.: US 2026/0067222 A1
(43) Pub. Date: Mar. 5, 2026

(54) ELECTRONIC DEVICE FOR TRANSMITTING ACK AND OPERATION METHOD THEREOF

(71) Applicant: Samsung Electronics Co., Ltd., Suwon-si (KR)

(72) Inventors: Jusung LEE, Suwon-si (KR); Dongho KIM, Suwon-si (KR); Injae SONG, Suwon-si (KR); Yongchul LEE, Suwon-si (KR); Haesung OH, Suwon-si (KR); Kyunghoon LEE, Suwon-si (KR); Soomin LEE, Suwon-si (KR)

(21) Appl. No.: 19/382,918

(22) Filed: Nov. 7, 2025

Related U.S. Application Data
(63) Continuation of application No. PCT/KR2024/006150, filed on May 8, 2024.

(30) Foreign Application Priority Data
May 18, 2023 (KR) 10-2023-0064161
May 31, 2023 (KR) 10-2023-0070300

(51) Int. Cl. H04L 47/193; H04L 47/24

(52) U.S. Cl. CPC H04L 47/193; H04L 47/24

(57) ABSTRACT

An electronic device may include at least one communication processor and at least one application processor. The at least one communication processor may be configured to obtain a plurality of TCP ACKs generated on the basis of a network stack executed by the at least one application processor. The at least one communication processor may be configured to classify the plurality of TCP ACKs into a plurality of groups and store same in at least one buffer associated with the at least one communication processor. The at least one communication processor may be configured to fetch each of at least one TCP ACK from each of the plurality of groups on the basis of each of policies configured to correspond to each of the plurality of groups. The at least one communication processor may be configured to transmit at least a part of each of the fetched at least one TCP ACK. Various other embodiments are possible.

### CROSS-REFERENCE TO RELATED APPLICATIONS

This application is a continuation application of International Application No. PCT/KR2024/006150, filed on May 8, 2024, in the Korean Intellectual Property Receiving Office, and claiming priority to Korean Patent Application No. 10-2023-0064161 filed May 18, 2023 and Korean Patent Application No. 10-2023-0070300 filed May 31, 2023, the disclosures of which are all hereby incorporated by reference herein in their entireties.

### TECHNICAL FIELD

Certain example embodiments may relate to an electronic device transmitting an ACK and/or an operation method thereof.

### BACKGROUND

In a modern network environment, transmission of large-capacity data and/or securing of high bandwidth may be required. For this purpose, transmission control protocol (TCP) is being used. TCP is a protocol for ensuring reliable data transmission, and packet transmission from a transmitting entity to a receiving entity and acknowledgement (ACK) transmission from the receiving entity that has received the packet to the transmitting entity may be performed. The transmitting entity may identify the success of the transmitted packet based on whether the ACK is received from the receiving entity. The transmitting entity may perform, e.g., a flow control function that controls the packet transmission rate.

Meanwhile, as the transmission frequency of ACK increases, resources allocated for ACK transmission may also relatively increase. For example, when large-capacity download is performed, such as streaming a high-quality video file, the electronic device should transmit ACK segments corresponding to each of the received packets, and in this case, since the number of received packets is relatively large, a relatively large number of ACK segments may also be generated. Accordingly, a relatively large portion of uplink resources should be allocated for transmission of ACK segments, which may cause transmission delay.

TCP ACK aggregation technology may transmit only some ACKs without transmitting all generated ACK segments. For example, when the receiving entity receives a relatively large number of packets, it may generate multiple ACK segments, but may transmit only some ACKs rather than all ACK segments. Accordingly, even when relatively large-capacity download is performed, transmission of a relatively small number of ACKs may be possible, so a relatively small portion of uplink resources may be allocated.

### SUMMARY

In certain example embodiments, an electronic device may include at least one communication processor comprising processing circuitry, and at least one application processor comprising processing circuitry. The at least one communication processor may be configured to obtain a plurality of TCP ACKs generated based on a network stack executed in the at least one application processor. The at least one communication processor may be configured to classify and store the plurality of TCP ACKs by a plurality of groups in at least one buffer associated with the at least one communication processor. The at least one communication processor may be configured to fetch at least one TCP ACK from each of the plurality of groups based on policies set corresponding to each of the plurality of groups. The at least one communication processor may be configured to transmit at least a portion of each of the fetched at least one TCP ACK.

In certain example embodiments, in a storage medium storing at least one computer-readable instruction, the at least one instruction, when executed individually and/or collectively by at least one processor of an electronic device, may enable the electronic device to perform at least one operation. The at least one operation may include obtaining a plurality of TCP ACKs. The at least one operation may include classifying and storing the plurality of TCP ACKs by a plurality of groups. The at least one operation may include fetching at least one TCP ACK from each of the plurality of groups based on policies set corresponding to each of the plurality of groups. The at least one operation may include transmitting at least a portion of each of the fetched at least one TCP ACK.

In certain example embodiments, an operation method of an electronic device may include obtaining a plurality of TCP ACKs. The operation method of the electronic device may include classifying and storing the plurality of TCP ACKs by a plurality of groups. The operation method of the electronic device may include fetching at least one TCP ACK from each of the plurality of groups based on policies set corresponding to each of the plurality of groups. The operation method of the electronic device may include transmitting at least a portion of each of the fetched at least one TCP ACK.

### BRIEF DESCRIPTION OF DRAWINGS

FIG. 1 is a block diagram illustrating an electronic device in a network environment according to an example embodiment.

FIG. 2A is a block diagram illustrating an electronic device for supporting legacy network communication and 5G network communication according to an example embodiment.

FIG. 2B is a block diagram illustrating an electronic device for supporting legacy network communication and 5G network communication according to an example embodiment.

FIG. 3 is a view illustrating ACK generation according to an example embodiment.

FIG. 4 is a flowchart illustrating an operation method of an electronic device according to an example embodiment.

FIG. 5 is a view illustrating transmission of a TCP ACK segment according to an example embodiment.

FIG. 6A is a flowchart illustrating an operation method of an electronic device according to an example embodiment.

FIG. 6B is a flowchart illustrating an operation method of an electronic device according to an example embodiment.

FIG. 7A is a flowchart illustrating an operation method of an electronic device according to an example embodiment.

FIG. 7B is a view illustrating transmission of TCP according to an example embodiment.

FIG. 8A is a flowchart illustrating an operation method of an electronic device according to an example embodiment.

FIG. 8B is a view illustrating transmission of TCP ACK based on a policy according to an example embodiment.

FIG. 8C is a flowchart illustrating an operation method of an electronic device according to an example embodiment.

FIG. 8D is a flowchart illustrating an operation method of an electronic device according to an example embodiment.

FIG. 9A is a view illustrating policy determination according to an example embodiment.

FIG. 9B is an example of a policy according to an example embodiment.

FIG. 9C is a view illustrating fetching based on a policy according to an example embodiment.

FIG. 10A is a view illustrating policy determination according to an example embodiment.

FIG. 10B is a view illustrating policy determination according to an example embodiment.

### DETAILED DESCRIPTION

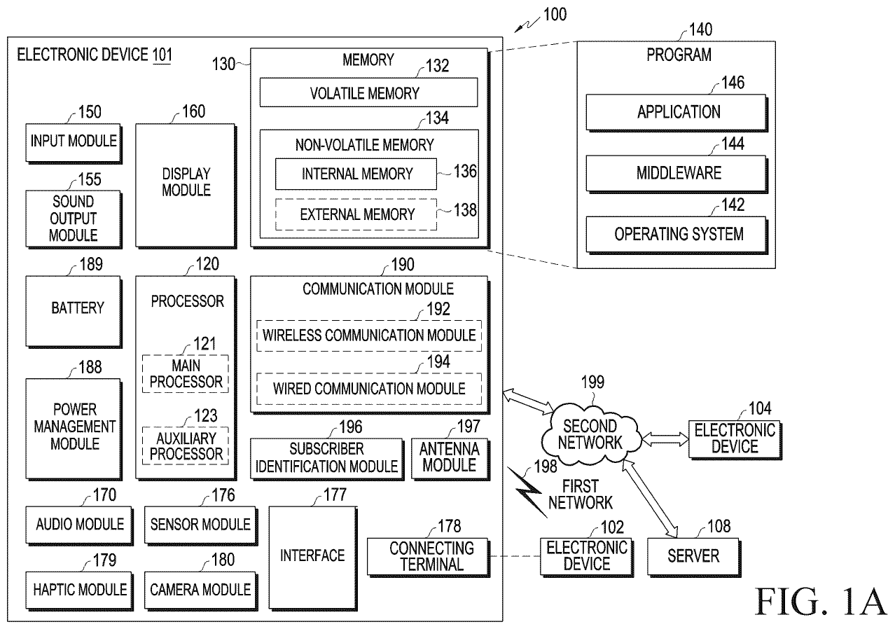

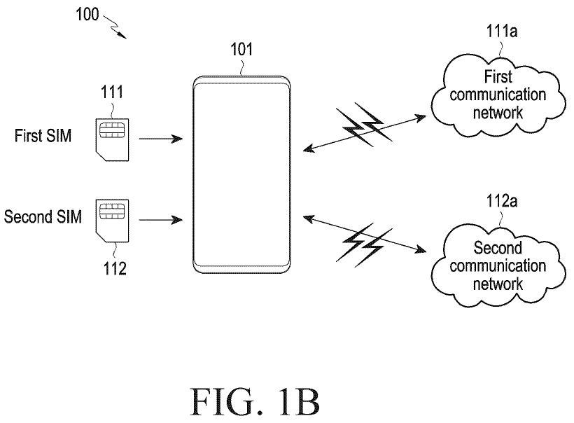

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). In certain example embodiments, the electronic device 101 may communicate with the electronic device 104 via the server 108. In certain example embodiments, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In certain example embodiments, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. In certain example embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. In certain example embodiments, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). In certain example embodiments, the auxiliary processor 123 (e.g., an image signal processor or a communication processor) may be implemented as part of another component (e.g., the camera module 180 or the communication module 190) functionally related to the auxiliary processor 123. In certain example embodiments, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. In certain example embodiments, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. In certain example embodiments, the display module 160 may include a touch sensor configured to detect a touch, or a pressure sensor configured to measure the intensity of a force generated by the touch.

The audio module 170 may convert a sound into an electrical signal and vice versa. In certain example embodiments, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. In certain example embodiments, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. In certain example embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). In certain example embodiments, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. In certain example embodiments, the haptic module 179 may include, for example, a motor, a piezoelectric element, or an electric stimulator.

The camera module 180 may capture a still image or moving images. In certain example embodiments, the camera module 180 may include one or more lenses, image sensors, image signal processors, or flashes.

The power management module 188 may manage power supplied to the electronic device 101. In certain example embodiments, the power management module 188 may be implemented as at least part of, for example, a power management integrated circuit (PMIC).

The battery 189 may supply power to at least one component of the electronic device 101. In certain example embodiments, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. In certain example embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). In certain example embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). In certain example embodiments, the antenna module 197 may include one antenna including a radiator formed of a conductor or conductive pattern formed on a substrate (e.g., a printed circuit board (PCB)). In certain example embodiments, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. In certain example embodiments, other parts (e.g., radio frequency integrated circuit (RFIC)) than the radiator may be further formed as part of the antenna module 197.

In certain example embodiments, the antenna module 197 may form a mmWave antenna module. In certain example embodiments, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In certain example embodiments, commands or data may be transmitted or received between the electronic device 101 and the external electronic device 104 via the server 108 coupled with the second network 199. The external electronic devices 102 or 104 each may be a device of the same or a different type from the electronic device 101. In certain example embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. In certain example embodiments, the external electronic device 104 or the server 108 may be included in the second network 199. The electronic device 101 may be applied to intelligent services (e.g., smart home, smart city, smart car, or healthcare) based on 5G communication technology or IoT-related technology.

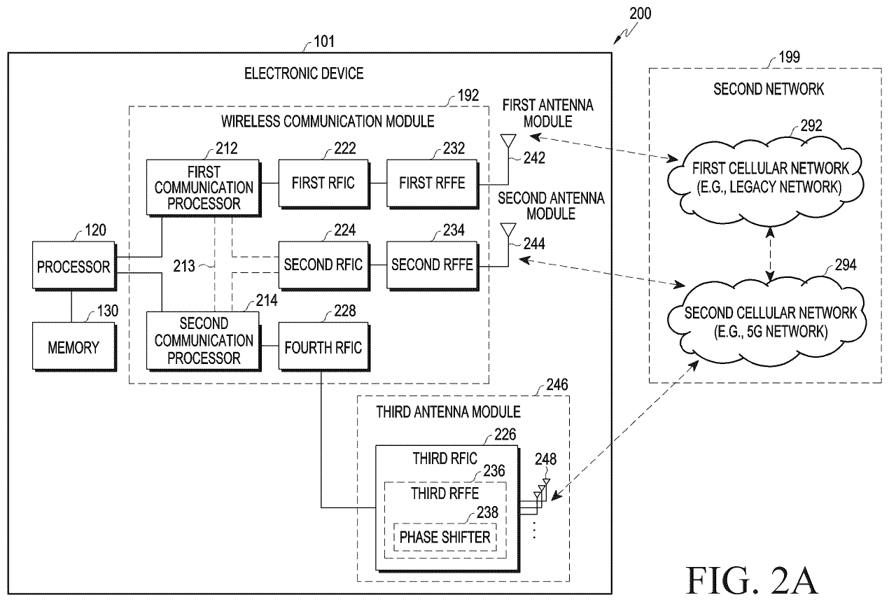

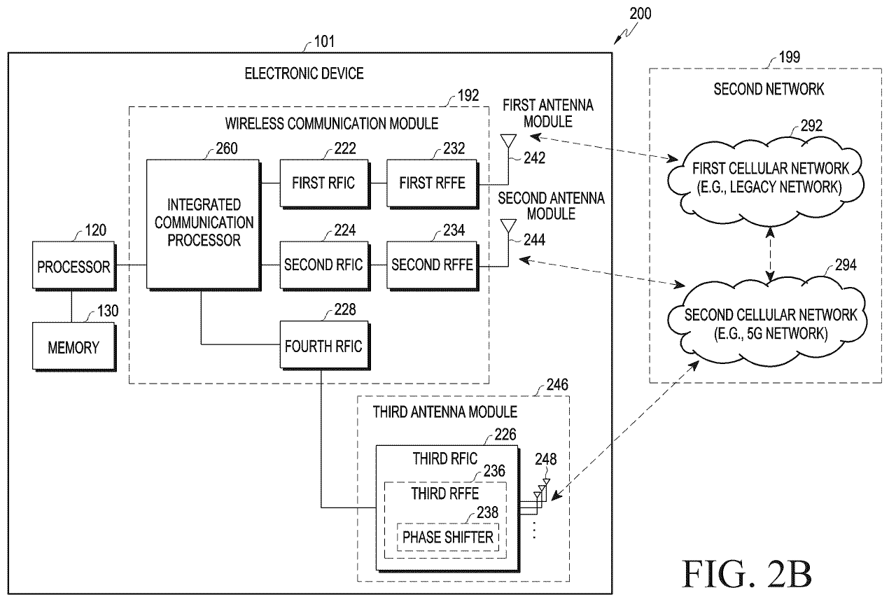

FIG. 2A is a block diagram 200 illustrating an electronic device 101 for supporting legacy network communication and 5G network communication according to an embodiment. Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. The second network 199 may include a first cellular network 292 and a second cellular network 294. In certain example embodiments, the electronic device 101 may further include at least one component among the components of FIG. 1, and the second network 199 may further include at least one other network. In certain example embodiments, the first communication processor 212, the second communication processor 214, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or be included as part of the third RFIC 226.

The first communication processor 212 may establish a communication channel of a band that is to be used for wireless communication with the first cellular network 292 or may support legacy network communication via the established communication channel. In certain example embodiments, the first cellular network may be a legacy network that includes second generation (2G), third generation (3G), fourth generation (4G), or long-term evolution (LTE) networks. The second communication processor 214 may establish a communication channel corresponding to a designated band (e.g., from about 6 GHz to about 60 GHz) among bands that are to be used for wireless communication with the second cellular network 294 or may support fifth generation (5G) network communication via the established communication channel. In certain example embodiments, the second cellular network 294 may be a 5G network defined by the 3rd generation partnership project (3GPP). Additionally, In certain example embodiments, the first communication processor 212 or the second communication processor 214 may establish a communication channel corresponding to another designated band (e.g., about 6 GHz or less) among the bands that are to be used for wireless communication with the second cellular network 294 or may support fifth generation (5G) network communication via the established communication channel.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to implementation, the first communication processor 212 may not be directly connected with the second communication processor 214. In this case, the first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

In certain example embodiments, the first communication processor 212 and the second communication processor 214 may be implemented in a single chip or a single package. In certain example embodiments, the first communication processor 212 or the second communication processor 214, along with the processor 120, an assistance processor 123, or communication module 190, may be formed in a single chip or single package. For example, as shown in FIG. 2B, an integrated communication processor 260 may support all of the functions for communication with the first cellular network 292 and the second cellular network 294.

As described above, at least one of the processor 120, the first communication processor 212, the second communication processor 214, or the integrated communication processor 260 may be implemented as a single chip or a single package. In this case, the single chip or single package may include memory (or storage means) storing instructions that cause at least some of operations performed according to an embodiment and a processing circuit (or operation circuit, but the term is not limited) for executing instructions.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second communication processor 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. In certain example embodiments, the third RFFE 236 may be formed as part of the third RFIC 226.

In certain example embodiments, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

In certain example embodiments, the first RFIC 222 and the second RFIC 224 may be implemented as at least part of a single chip or single package. In certain example embodiments, when the first RFIC 222 and the second RFIC 224 in FIG. 2A or 2B are implemented as a single chip or a single package, they may be implemented as an integrated RFIC. In this case, the integrated RFIC is connected to the first RFFE 232 and the second RFFE 234 to convert a baseband signal into a signal of a band supported by the first RFFE 232 and/or the second RFFE 234, and may transmit the converted signal to one of the first RFFE 232 and the second RFFE 234. In certain example embodiments, the first RFFE 232 and the second RFFE 234 may be implemented as at least part of a single chip or single package. In certain example embodiments, at least one of the first antenna module 242 or the second antenna module 244 may be omitted or be combined with another antenna module to process multi-band RF signals.

In certain example embodiments, the third RFIC 226 and the antenna 248 may be disposed on the same substrate to form the third antenna module 246. For example, the wireless communication module 192 or the processor 120 may be disposed on a first substrate (e.g., a main printed circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second network 294 (e.g., a 5G network).

In certain example embodiments, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

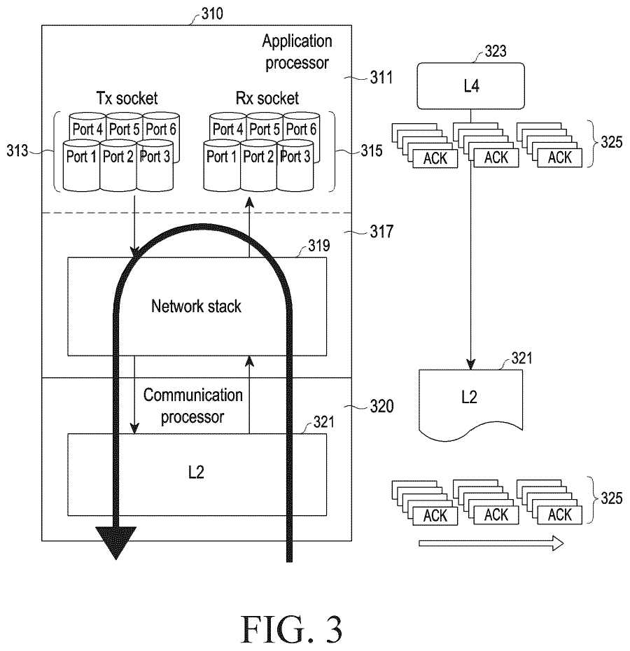

FIG. 3 is a view illustrating ACK generation according to an embodiment.

In certain example embodiments, an electronic device 101 may include an application processor 310 (e.g., the processor 120) and a communication processor 320 (e.g., at least one of the first communication processor 212, the second communication processor 214, or the integrated communication processor 260). The application processor 310 may, e.g., execute at least one application. A user space 310 and a kernel 317 may be defined (or executed) by the application processor 310. The application processor 310 may, e.g., execute at least one application in the user space 310, and the at least one application may be a client in a server-client structure.

In certain example embodiments, the application processor 310 may execute (or create) at least one socket, e.g., transmission sockets 313 and reception sockets 315 based on TCP. A socket is an interface for transmitting/receiving data between a client and a server, and a client (e.g., at least one application) may transmit a request to a server through a socket and may receive a response from the server through a socket. Each of the clients may transmit data through each of the transmission sockets 313. Each of the clients may receive data through each of the reception sockets 315. Each of the sockets 313, 315 may be identified (or defined) based on, e.g., an address (e.g., an internet protocol (IP) address) and/or a port number, but there is no limitation.

In certain example embodiments, in the kernel 317, a network stack 319 may be executed (or defined). The network stack 319 may, e.g., transmit data received from an application through at least some of the transmission sockets 313 to the communication processor 320 (e.g., the L2 layer 321) (e.g., by performing additional processing). The network stack 319 is, e.g., a stack for communication with a network, and may provide data received from the communication processor 320 (e.g., the L2 layer 321) to an application through at least some of the reception sockets 315 (e.g., by performing additional processing). The network stack 319 may generate a TCP ACK 325 (which may also be referred to as a TCP ACK segment, a TCP data segment, or an ACK) associated with completion (or success) of reception of the received data based on receiving data through at least some of the reception sockets 315 (or successful reception) from the communication processor 320 (e.g., the L2 layer 321). The network stack 319 may transmit the generated TCP ACKs 325 to the communication processor 320 (e.g., the L2 layer 321). For example, an IP packet including a TCP ACK segment may be provided to the L2 layer 321. For example, an IP packet corresponding to each of the TCP ACKs 325 may be provided to the L2 layer 321, and those skilled in the art will understand that providing an ACK to the L2 layer 321 may be understood as providing an IP packet including a TCP ACK segment. The communication processor 320 may transmit the TCP ACKs 325 to a network. For example, the communication processor 320 may receive an IP packet including a TCP ACK segment as described above, and may transmit data corresponding to the IP packet to the network. Those skilled in the art will understand that transmission of a TCP ACK to a network based on the L2 layer 321 may mean, e.g., transmission of data corresponding to an IP packet including a TCP ACK segment to the network. For example, the L4 layer 323 including the network stack 319 may generate the TCP ACKs 325 and provide them to the L2 layer 321. As described above, IP packets including TCP ACK segments may be provided to the L2 layer 321, and this may also be named as providing the TCP ACKs 325. The L2 layer 321 may transmit all of the TCP ACKs 325 to the network. The L2 layer 321 may allocate at least some of uplink resources for transmission of the TCP ACKs 325 to the network for the received TCP ACKs 325. When all generated TCP ACKs 325 are transmitted to the network, allocation of a relatively large number of resources among uplink resources may be required. In particular, when the electronic device 101 performs large-capacity download, it may receive a large number of received data, and accordingly, a relatively large number of resources among uplink resources may be allocated for transmission of all TCP ACKs 325.

In certain example embodiments, the electronic device 101 may transmit only some of the TCP ACKs 325 to the network. For example, the electronic device 101 may perform grouping for the TCP ACKs 325, and may select TCP ACKs to transmit from among all TCP ACKs 325 based on a policy set for each group, which is described below. Accordingly, even when large-capacity download is performed, a relatively small portion of uplink resources may be allocated for TCP ACK transmission.

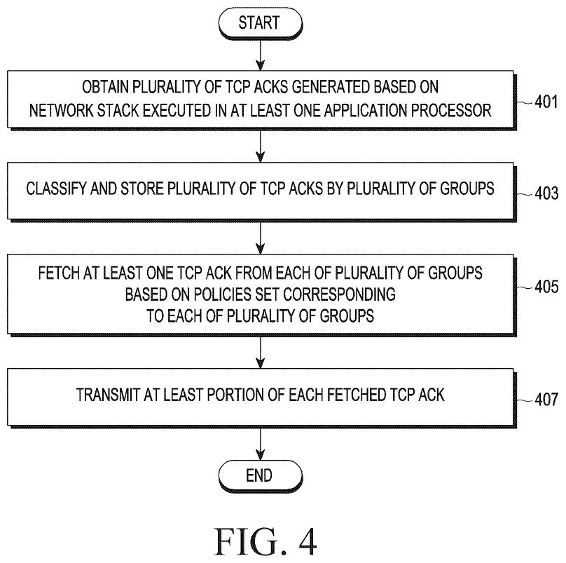

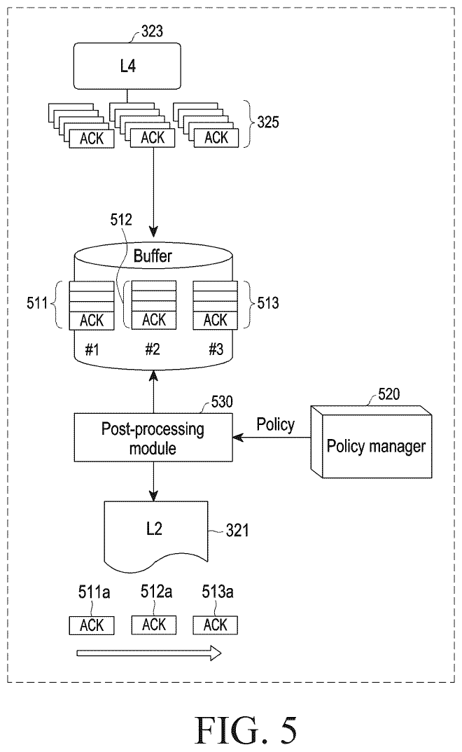

FIG. 4 is a flowchart illustrating an operation method of an electronic device according to an embodiment. The embodiment of FIG. 4 is described with reference to FIG. 5. FIG. 5 is a view illustrating transmission of a TCP ACK segment according to an embodiment.

Referring to FIGS. 4 and 5, In certain example embodiments, the electronic device 101 (e.g., the communication processor 320) may, in operation 401, obtain a plurality of TCP ACKs 325 generated based on the network stack 319 (or the L4 layer 323 of FIG. 5) executed in the at least one application processor 310. For example, the communication processor 320 may obtain the plurality of TCP ACKs 325 from a shared memory of the application processor 310 and the communication processor 320, or may directly obtain the plurality of TCP ACKs 325 from the application processor 310, but there is no limitation on the method. As described above, the network stack 319 may generate the TCP ACKs 325 based on data reception from the L2 layer 321 and provide them to the communication processor 320. As described above, providing the TCP ACKs 325 to the communication processor 320 may be, e.g., providing an IP packet including a TCP ACK segment to the communication processor 320, but there is no limitation.

In certain example embodiments, the electronic device 101 may, in operation 403, classify and store the plurality of TCP ACKs 325 by a plurality of groups. For example, as illustrated in FIG. 5, a first TCP ACK group 511, a second TCP ACK group 512, and an Nth TCP ACK group 513 may be stored in a buffer 510 included in (or accessible by) the communication processor 320. For example, groups may be set based on an IP address (source IP address and/or destination IP address), a port number (reception port number and/or transmission port number), and/or network interface identification information (e.g., rmnet), but there is no limitation on the type of information (or criteria) for group setting or the number of groups (N). For example, the number of reception sockets and the number of groups may be the same, but this is also exemplary and may be set differently.

In certain example embodiments, the electronic device 101 may, in operation 405, fetch at least one TCP ACK from each of the plurality of groups based on policies set corresponding to each of the plurality of groups 511, 512, 513. Here, the policy may include the number of TCP ACKs fetched per unit time, a fetch interval, and/or a fetch priority, but there is no limitation, and this is described below. For example, as illustrated in FIG. 5, a post-processing module 530 executed by (or included in) the communication processor 320 may fetch TCP ACKs based on a per-group policy provided from a policy manager 520 executed by (or included in) the communication processor 320. For example, the post-processing module 530 may fetch at least one first TCP ACK from the first TCP ACK group 511 based on a first policy set for the first TCP ACK group 511. The post-processing module 530 may provide one TCP ACK 511a (e.g., which may be the TCP ACK having the largest sequence number but there is no limitation) among the at least one first TCP ACK to the L2 layer 321. For example, the post-processing module 530 may fetch at least one second TCP ACK from the second TCP ACK group 512 based on a second policy set for the second TCP ACK group 512. The post-processing module 530 may provide one TCP ACK 512a (e.g., which may be the TCP ACK having the largest sequence number but there is no limitation) among the at least one second TCP ACK to the L2 layer 321, and the process of providing one TCP ACK 513a from the Nth TCP group 513 to the L2 layer 321 may be substantially the same. For example, the policy manager 520 may set a policy for each of the first TCP ACK group 511, the second TCP ACK group 512, and the Nth TCP ACK group 513. The policy manager 520 may perform a per-group policy based on, e.g., TCP-related information and/or network-related information (which may also be referred to as L2 layer, L3 layer, and/or L4 layer-related information), which is described below. The policy manager 520 (or a monitoring task) may, e.g., obtain TCP-related information and/or a network, and may, e.g., store it in a table format.

In certain example embodiments, the electronic device 101 may, in operation 407, transmit at least a portion 511a, 512a, 513a of each of the fetched at least one TCP ACK segment to the network. In an example, the electronic device 101 may transmit to the network a TCP ACK 511a selected from among the at least one first TCP ACK fetched from the first TCP ACK group 511, a TCP ACK 512a selected from among the at least one second TCP ACK fetched from the second TCP ACK group 512, and a TCP ACK 513a selected from among the at least one Nth TCP ACK fetched from the Nth TCP ACK group 513. Meanwhile, transmission of a TCP ACK to the network may mean, as described above, transmission of data including at least a portion of a TCP ACK segment to the network.

As described above, the electronic device 101 may transmit only some TCP ACKs, not all generated TCP ACKs, to the network, and accordingly, a relatively small portion of uplink resources may be allocated for TCP ACK transmission. For example, as is described below, the electronic device 101 may establish a policy for fetching for each group based on TCP-related information and/or network-related information, and accordingly, TCP ACK transmission that adaptively responds to TCP-related information and/or network-related information that changes in real-time may be possible. Meanwhile, TCP ACKs that are not transmitted may be discarded. In certain example embodiments, the electronic device 101 may also determine TCP ACKs to be transmitted based on whether packet duplication occurs. For example, when packet duplication is performed for retransmission, the electronic device 101 may transmit the duplicated TCP ACK without discarding it. For example, the electronic device 101 may be configured to transmit only some TCP ACKs, not all generated TCP ACKs, to the network when packet duplication has not occurred.

Meanwhile, in the embodiments of FIGS. 4 and 5, it has been described that the communication processor 320 transmits only some of the TCP ACKs 325 generated by the application processor 310 to the network, but this is exemplary. For example, the application processor 310 may be implemented to generate only TCP ACKs corresponding to some of the received data, rather than generating TCP ACKs corresponding to all received data. For example, the application processor 310 may select TCP ACKs to generate (or received data for which to generate corresponding TCP ACKs) based on a policy set for each socket, and accordingly, TCP ACKs corresponding to some of all received data may be generated. Those skilled in the art will understand that operations for selecting some of the TCP ACKs by the communication processor 320 according to embodiments of the disclosure may be redisposed by, e.g., generation of TCP ACKs corresponding to some of all received data by the application processor 310.

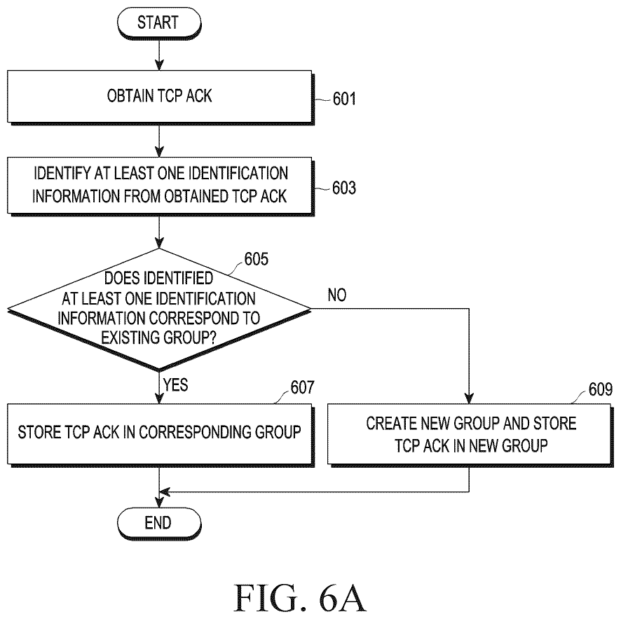

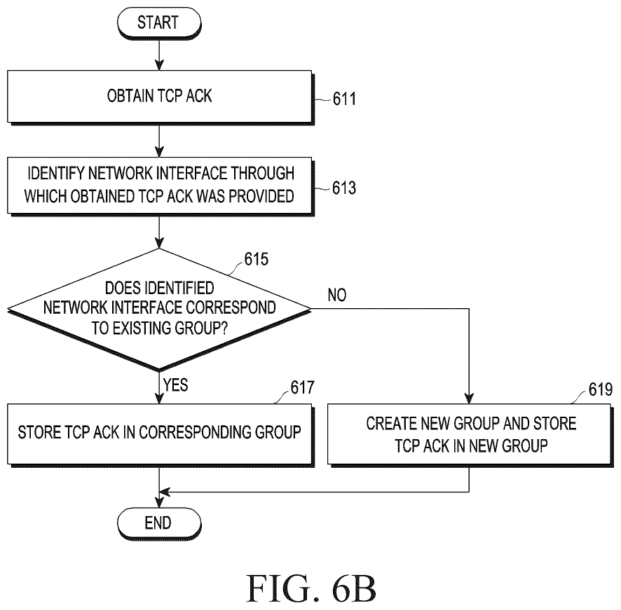

FIG. 6A is a flowchart illustrating an operation method of an electronic device according to an embodiment.

In certain example embodiments, the electronic device 101 (e.g., the communication processor 320) may, in operation 601, obtain a TCP ACK. For example, the communication processor 320 may obtain a TCP ACK from a shared memory of the application processor 310 and the communication processor 320, or may directly obtain a TCP ACK from the application processor 310, but there is no limitation on the method. The electronic device 101 may, in operation 603, identify at least one identification information from the obtained TCP ACK. For example, the electronic device 101 may identify an IP address (source IP address and/or destination IP address) and/or a port number (reception port number and/or transmission port number) as the at least one identification information, but there is no limitation on the type of identification information. The electronic device 101 may, in operation 605, identify whether the identified at least one identification information corresponds to an existing group. As described above, the electronic device 101 may manage groups based on an IP address (source IP address and/or destination IP address) and/or a port number (reception port number and/or transmission port number). The electronic device 101 may identify whether the identification information identified in operation 603 corresponds to the IP address (source IP address and/or destination IP address) and/or port number (reception port number and/or transmission port number) of a previously created group. For example, when the identified at least one identification information corresponds to an existing group (operation 605—Yes), the electronic device 101 may, in operation 607, store the TCP ACK in the corresponding group. When the identified at least one identification information does not correspond to an existing group (operation 605—No), the electronic device 101 may, in operation 609, create a new group and store the TCP ACK in the new group. Accordingly, as described in connection to FIG. 5, the generated TCP ACKs may be grouped.

FIG. 6B is a flowchart illustrating an operation method of an electronic device according to an embodiment.

In certain example embodiments, the electronic device 101 (e.g., the communication processor 320) may, in operation 611, obtain a TCP ACK. For example, the communication processor 320 may obtain a TCP ACK from a shared memory of the application processor 310 and the communication processor 320, or may directly obtain a TCP ACK from the application processor 310, but there is no limitation on the method. The electronic device 101 may, in operation 613, identify a network interface (e.g., rmnet) through which the obtained TCP ACK was provided. The electronic device 101 may, in operation 615, identify whether the identified network interface corresponds to an existing group. As described above, the electronic device 101 may manage groups based on a network interface. The electronic device 101 may identify whether the network interface identified in operation 613 corresponds to the network interface of a previously created group. For example, when the identified network interface corresponds to an existing group (operation 615—Yes), the electronic device 101 may, in operation 617, store the TCP ACK in the corresponding group. When the identified network interface does not correspond to an existing group (operation 615—No), the electronic device 101 may, in operation 619, create a new group and store the TCP ACK in the new group. Accordingly, as described in connection to FIG. 5, the generated TCP ACKs may be grouped.

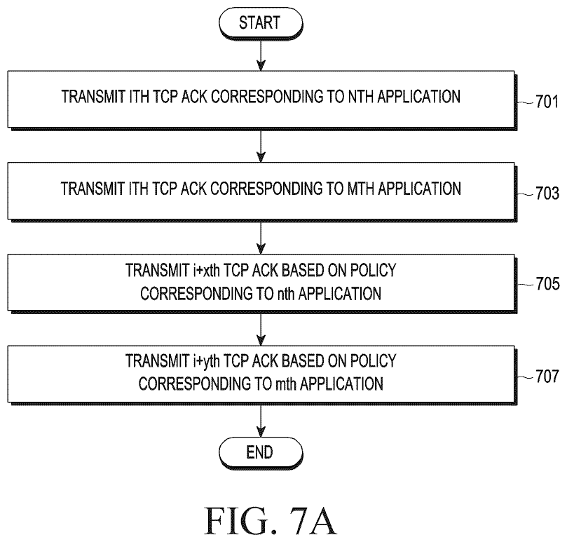

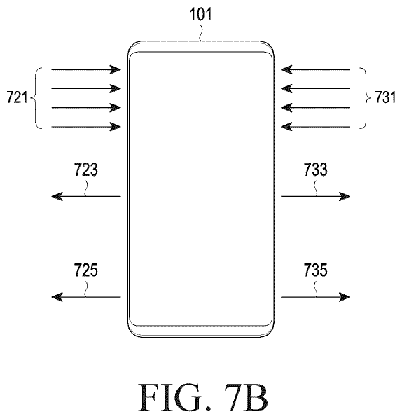

FIG. 7A is a flowchart illustrating an operation method of an electronic device according to an embodiment. The embodiment of FIG. 7A is described with reference to FIG. 7B. FIG. 7B is a view illustrating transmission of TCP according to an embodiment.

Referring to FIGS. 7A and 7B, In certain example embodiments, the electronic device 101 (e.g., the communication processor 320) may, in operation 701, transmit an ith TCP ACK 723 corresponding to an nth application. The electronic device 101 may, in operation 703, transmit an ith TCP ACK 723 corresponding to an mth application. For example, the electronic device 101 may execute the nth application and the mth application. For example, a socket corresponding to the nth application may be created based on execution of the nth application, and a socket corresponding to the mth application may be created based on execution of the mth application. The electronic device 101 may receive received data 721 based on the nth application from the network. The electronic device 101 may transmit the ith TCP ACK 723 corresponding to any one of the received data 721. The electronic device 101 may receive received data 731 based on the mth application from the network. The electronic device 101 may transmit the ith TCP ACK 723 corresponding to any one of the received data 731. Meanwhile, at least some of the received data 721 and at least some of the received data 731 may be included together in one unit period (e.g., a frame or subframe), or may be included in different unit periods, and there is no limitation.

In certain example embodiments, the electronic device 101 may, in operation 705, transmit an i+xth TCP ACK 725 based on a policy corresponding to the nth application. The electronic device 101 may, in operation 707, transmit an i+yth TCP ACK 735 based on a policy corresponding to the mth application. As described above, the electronic device 101 may set a policy for each group of TCP ACKs. At least some of the criteria for distinguishing groups of TCP ACKs may be the same as, e.g., at least some of the criteria for distinguishing applications. For example, groups of TCP ACKs may be distinguished by port numbers, and applications may also be distinguished by port numbers, and accordingly, policies may be set for each application. Or, the electronic device 101 may be implemented to set a policy for each application, according to the implementation. For example, the network stack 319 may generate TCP ACKs corresponding to the received data 721 corresponding to the nth application. The electronic device 101 may fetch at least one TCP ACK from among the TCP ACKs generated based on a policy corresponding to the nth application, and may transmit the TCP ACK having the largest sequence number (SN) among them to the network. The network stack 319 may generate TCP ACKs corresponding to the received data 731 corresponding to the mth application. The electronic device 101 may fetch at least one TCP ACK from among the TCP ACKs generated based on a policy corresponding to the mth application, and may transmit the TCP ACK having the largest SN among them to the network. Depending on the policy, the fetch number for the mth application and the fetch number for the nth application may be different. Accordingly, the difference in SN (e.g., x) between consecutive (or adjacent) TCP ACKs 723, 725 corresponding to the nth application and the difference in SN (e.g., y) between consecutive (or adjacent) TCP ACKs 733, 735 corresponding to the mth application may be different. Meanwhile, those skilled in the art will understand that if at least some of the policy corresponding to the nth application and the policy corresponding to the mth application are the same, the difference in SN between consecutive (or adjacent) TCP ACKs 723, 725 corresponding to the nth application and the difference in SN between consecutive (or adjacent) TCP ACKs 733, 735 corresponding to the mth application may be the same.

Meanwhile, as is described below, policies for each application (or each group) may be set based on TCP information and/or network information, and accordingly may be updated based on changes in TCP information and/or network information. For example, a first MCS value may be set for reception of received data corresponding to the nth application during a first period, and a second MCS value may be set for reception of received data corresponding to the nth application during a second period. As is described below, e.g., a policy may be set based on an MCS value, which is one example of network information, and the policy may be updated according to changes in the MCS value. For example, the difference in SN between TCP ACKs associated with the nth application during the first period by the electronic device 101 may be different from the difference in SN between TCP ACKs associated with the nth application during the second period.

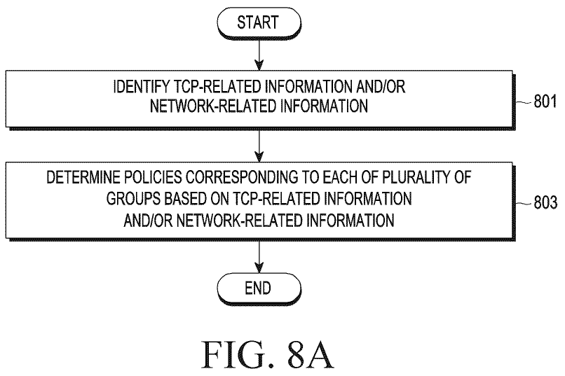

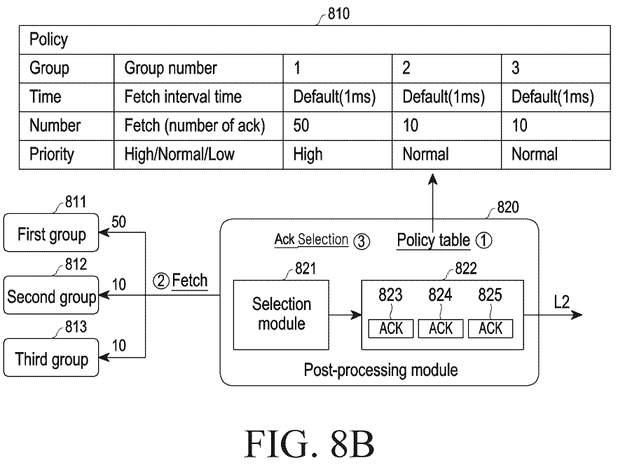

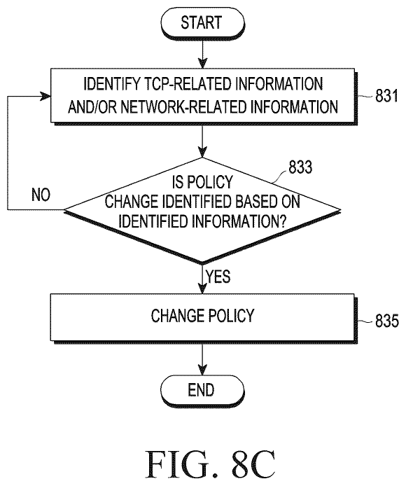

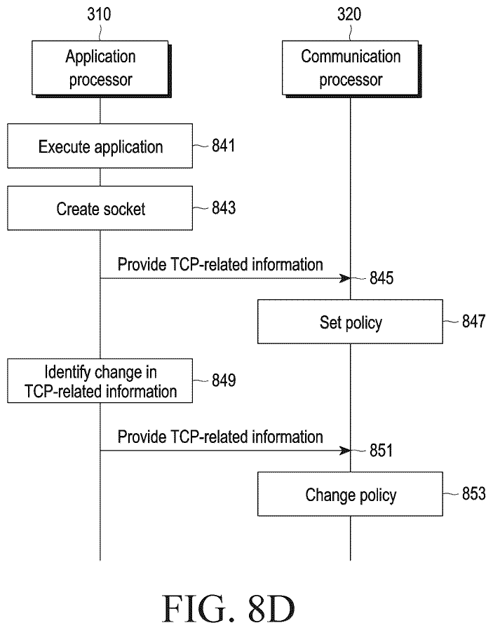

FIG. 8A is a flowchart illustrating an operation method of an electronic device according to an embodiment.

In certain example embodiments, the electronic device 101 (e.g., the communication processor 320) may, in operation 801, identify TCP-related information and/or network-related information. The electronic device 101 may set (or update) a policy for each of the plurality of groups based on the TCP-related information and/or network-related information. For example, the network-related information may include modulation and coding scheme (MCS), block error rate (BLER), reception strength (e.g., reference signal received power (RSRP), reference signal received quality (RSRQ), signal-to-interference-noise ratio (SINR), and/or received signal strength indicator (RSSI)), quality of service (QoS), QoS class identifier (QCI), radio access technology (RAT), and/or packet data network (PDN) connection (or protocol data unit (PDU) session) identification information, but there is no limitation. For example, the TCP-related information may include an address (e.g., an internet protocol (IP) address), a port number, ACK throughput (ACK TP), and/or priority, but there is no limitation.

For example, the electronic device 101 may identify an uplink capacity based on the MCS. For example, the electronic device 101 may identify an uplink capacity corresponding to the MCS and/or transport block size (TBS) based on 3^{rd} generation partnership project (3GPP) technical specification (TS) 36.213. The electronic device 101 may identify the size of a TCP ACK. The electronic device 101 may identify a fetch interval based on the TCP ACK size and the identified uplink capacity. For example, the fetch interval may be set such that the product of the uplink capacity and the fetch interval is greater than the size of at least one TCP ACK, which is described below.

For example, the electronic device 101 may set a fetch number based on ACK throughput (ACK TP). For example, the electronic device 101 may identify (or measure, or monitor) the ACK throughput (e.g., which may be in units of bps but there is no limitation). For example, the application processor 310 may provide a TCP ACK to the communication processor 320 after receiving received data, and may identify the ACK TP based on the sum of sizes of TCP ACKs generated per unit time. In this case, the application processor 310 may provide the identified ACK TP to the communication processor 320. The communication processor 320 may identify the ACK TP based on the sum of sizes of TCP ACKs read from a shared memory (or ring buffer, or DMA). The communication processor 320 may identify the ACK TP based on the sum of sizes of TCP ACKs provided from the application processor 310. For example, the electronic device 101 may identify the number of TCP ACKs fetched per identified fetch interval, e.g., a fetch number, based on the ACK TP and the uplink capacity of the network.

FIG. 8B is a view illustrating transmission of TCP ACK based on a policy according to an embodiment.

In certain example embodiments, a post-processing module 820 may refer to a policy table 810. The policy table 810 may include policies for each group. For example, for a first group, “time” (or fetch interval) may be set to 1 ms, “number” (or fetch number) may be set to 50, and priority may be set to high. For example, based on a relatively high MCS being set for a PDN connection corresponding to the first group, the electronic device 101 may set the priority of the first group to high, but there is no limitation on the method of setting priority. For example, for a first group, “time” (or fetch interval) may be set to 1 ms, “number” (or fetch number) may be set to 50, and priority may be set to high. For example, for a second group and a third group, “time” (or fetch interval) may be set to 1 ms, “number” (or fetch number) may be set to 10, and priority may be set to normal.

In certain example embodiments, the post-processing module 820 may fetch at least one TCP ACK from a first group 811 stored in a buffer based on a policy set for the first group, and may fetch, e.g., 50 TCP ACKs in 1 ms. The post-processing module 820 may perform fetching preferentially over other groups based on the priority set for the first group being high. The post-processing module 820 may fetch at least one TCP ACK from a second group 812 stored in the buffer based on a policy set for the second group, and may fetch, e.g., 10 TCP ACKs in 1 ms. The post-processing module 820 may fetch at least one TCP ACK from a third group 813 stored in the buffer based on a policy set for the third group, and may fetch, e.g., 10 TCP ACKs in 1 ms. For example, the same priority may be set for the second group and the third group. In this case, the post-processing module 820 may, e.g., randomly select one of the second group and the third group to perform fetching, or may perform fetching based on a designated order, but there is no limitation on the method of determining the order.

In certain example embodiments, a selection module 821 executed by or included in the communication processor 320 may select a TCP ACK for transmission from the fetched TCP ACKs and provide it to a queue 822. For example, the selection module 821 may select the TCP ACK having the largest SN among the fetched at least one TCP ACK. For example, the selection module 821 may provide a TCP ACK 825 having the largest SN among the at least one TCP ACK fetched from the first group 811 to the queue 822. For example, as fetching from the first group 811 is performed first based on the priority corresponding to the first group being high, the TCP ACK 825 corresponding to the first group 811 may also be input to the queue 822 first. Meanwhile, a TCP ACK 823 having the largest SN among the at least one TCP ACK fetched from the second group 812 and a TCP ACK 824 having the largest SN among the at least one TCP ACK fetched from the third group 813 may also be provided to the queue 822. The TCP ACKs 823, 824, 825 provided to the queue 822 may be sequentially provided to the L2 layer, for example.

FIG. 8C is a flowchart illustrating an operation method of an electronic device according to an embodiment.

In certain example embodiments, the electronic device 101 (e.g., the communication processor 320) may, in operation 831, identify TCP-related information and/or network-related information. The electronic device 101 may, in operation 833, identify whether a change in policy is identified based on the identified information. For example, as described above, the communication processor 320 may receive information about ACK TP among TCP-related information from the application processor 310 at a designated cycle or when there is a change. Or, the communication processor 320 may identify information about ACK TP, which is TCP-related information, at a designated cycle (or based on events). The electronic device 101 may, e.g., identify that information about ACK TP has changed, and accordingly may identify whether a policy change is required. The electronic device 101 may also identify, e.g., a change in information about MCS, which is network-related information. For example, when the degree of change in information does not satisfy a designated change condition, the electronic device 101 may identify that a policy change is not required. For example, when the degree of change in ACK TP is less than a threshold degree of change, the electronic device 101 may identify that a policy change is not required. When it is identified that a policy change is required (833—Yes), the electronic device 101 may, in operation 835, change the policy. The electronic device 101 may, e.g., set a policy based on the changed information based on the method described above. Or, according to the implementation, the electronic device 101 may immediately perform a policy change when a change in information is identified.

FIG. 8D is a flowchart illustrating an operation method of an electronic device according to an embodiment.

In certain example embodiments, the application processor 310 may, in operation 841, execute an application. The application processor 310 may, in operation 843, create a socket corresponding to the executed application. The application processor 310 may, in operation 845, provide TCP-related information. For example, the application processor 310 may provide an IP address (source IP address and/or destination IP address), a port number (reception port number and/or transmission port number), network interface identification information (e.g., rmnet), and/or ACK TP to the communication processor 320. The communication processor 320 may, in operation 847, set a policy based on the received TCP-related information. The communication processor 320 may also set a policy based on network-related information in addition to the received TCP-related information. The application processor 310 may, in operation 849, identify a change in TCP-related information. For example, the application processor 310 may identify a change in ACK TP, but there is no limitation on the type of information that changes. The application processor 310 may, in operation 851, provide TCP-related information (or change information) to the communication processor 320. The communication processor 320 may, in operation 853, set a policy based on the received TCP-related information (or change information). The communication processor 320 may also set a policy based on network-related information in addition to the received TCP-related information. For example, network-related information may also change, and the electronic device 101 may also update a policy based on the changed network-related information. Or, although not illustrated, the electronic device 101 may also update a policy based only on changes in network-related information. According to the above, the number and/or interval of TCP ACKs transmitted to the network may be adjusted adaptively to an environment that changes in real-time.

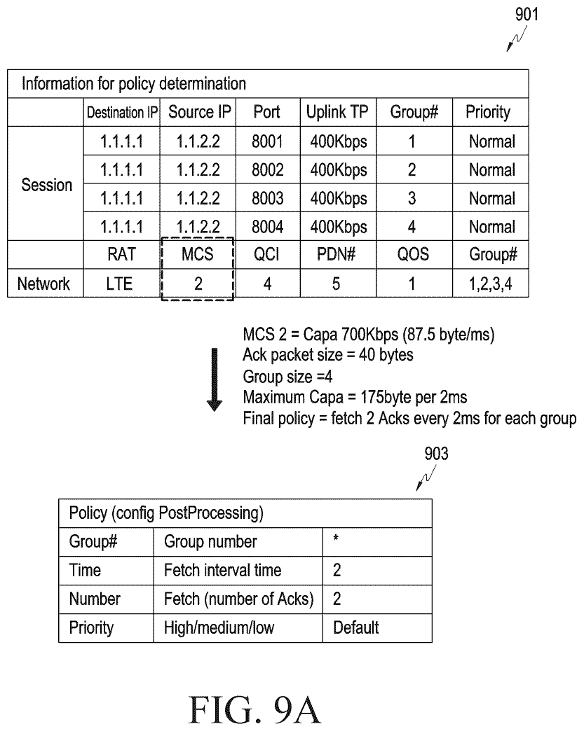

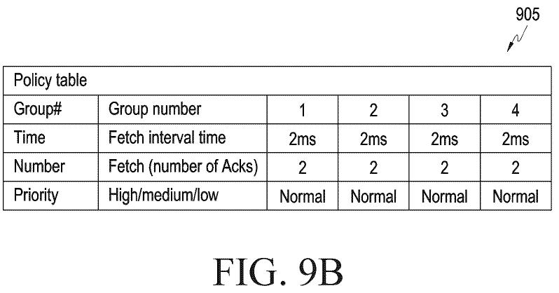

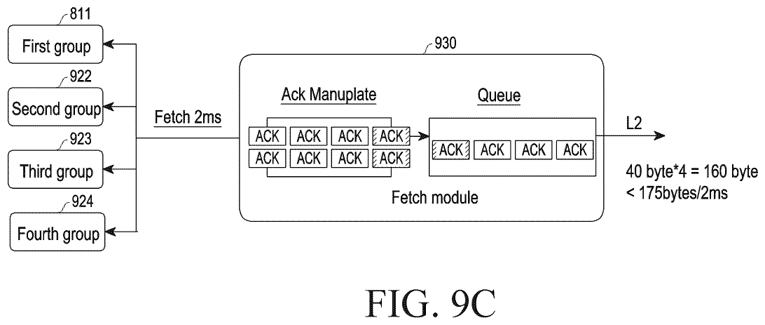

FIG. 9A is a view illustrating policy determination according to an embodiment. FIG. 9A is described with reference to FIGS. 9B and 9C. FIG. 9B is an example of a policy according to an embodiment. FIG. 9C is a view illustrating fetching based on a policy according to an embodiment.

In certain example embodiments, the electronic device 101 (e.g., the communication processor 320) may identify information 901 for policy determination. The information 901 for policy determination may include, e.g., TCP-related information and/or network-related information. In the embodiment of FIG. 9A, the information 901 may include address information (e.g., destination IP address (Dest. IP) and source IP address (Src.IP)) and port number (Port) corresponding to each of four groups (group #1, group #2, group #3, group #4). Meanwhile, in the information 901 of FIG. 9A, even though the four groups (group #1, group #2, group #3, group #4) include the same address, the four groups (group #1, group #2, group #3, group #4) may be distinguished as the port numbers are different. Meanwhile, the four groups (group #1, group #2, group #3, group #4) including the same address is exemplary and may be at least partially different. For the four groups (group #1, group #2, group #3, group #4), e.g., the same priority has been described as being the same as “normal,” but this is exemplary and may be at least partially different. For example, a plurality of TCP sessions corresponding to a plurality of different port numbers for the same IP address may be created corresponding to one PDN connection, and this may be named multi-stream TCP-based TCP packet transmission. For example, TP measurement applications (or other applications) of Ookla, Speedtest, or Datum may create multiple ports for the same IP address for efficient packet transmission, and accordingly multi-stream TCP sessions may be created, but there is no limitation.

The information 901 may include ACK throughput (ACK TP). As described above, the communication processor 320 may receive information about ACK throughput (ACK TP) from the application processor 310, or may identify (or measure, or monitor) ACK throughput (ACK TP). The information 901 may include, as network-related information, information about RAT, MCS, QCI, PDN connection identification information (PDN #), QoS, and groups (Group #) corresponding thereto. For example, in the example of FIG. 9A, the four groups (group #1, group #2, group #3, group #4) may correspond to a RAT of “LTE” (or E-UTRA), an MCS of “2”, a “QCI” of 4, PDN connection identification information of “5”, and a QoS of “1”. Meanwhile, in the example of FIG. 9A, network-related information corresponding to one session (or PDN connection) has been described, but those skilled in the art will understand that when multiple sessions are established, multiple NW information may be managed correspondingly.

In certain example embodiments, the electronic device 101 may identify an uplink capacity based on the MCS. For example, the electronic device 101 may identify an uplink capacity of “7000 Kbps=87.5 byte/ms” based on the MCS of “2”. As described above, the electronic device 101 may identify an uplink capacity of “7000 Kbps=87.5 byte/ms” corresponding to the MCS of “2” based on, e.g., 3GPP TS 36.213, but there is no limitation on the identification method. The electronic device 101 may identify the packet size of a TCP ACK as, e.g., “40 bytes”. The electronic device 101 may identify 4×40 bytes=160 bytes by multiplying the total number of groups (e.g., which may be the number of sessions), which is 4, by “40 bytes”, which is the packet size of a TCP ACK. As described above, the electronic device 101 may identify that the uplink capacity is “87.5 byte/ms” and the product of the TCP ACK packet size and the number of groups is “160 bytes”. The electronic device 101 may determine the fetch interval such that, e.g., the product of the uplink capacity and the fetch interval (e.g., MAX capa) is greater than the product of the TCP ACK packet size and the number of groups. For example, the electronic device 101 may determine the fetch interval such that the product of “87.5 byte/ms” and the fetch interval is greater than “160 bytes”, and accordingly may determine the fetch interval as 2 ms. Accordingly, “175 bytes”, which is the product of “87.5 byte/ms” and the fetch interval “2 ms”, may be greater than “160 bytes”.

In certain example embodiments, the electronic device 101 may also identify a fetch number based on, e.g., ACK TP. The electronic device 101 may identify, e.g., that the ACK TP for each group is “400 Kbps”. The electronic device 101 may identify that the sum of ACK TP corresponding to the four groups is “400 Kbps”×4, which is “1.6 Mbps”. The electronic device 101 may determine the fetch number such that, e.g., the product of the fetch number and the uplink capacity of the network is greater than the sum of ACK TP. For example, the electronic device 101 may determine as the fetch number the minimum value, or a low value, of the fetch number such that the product of the uplink capacity of the network, 700 kbps, and the fetch number is greater than the sum of ACK TP, “1.6 Mbps”, and may determine the fetch number as “2”, for example.

Meanwhile, as described above, the identification of the fetch interval based on the MCS (or UL capacity identified based on the MCS), the size of TCP ACK, and the number of groups is exemplary, and the electronic device 101 may also identify a fetch interval based on, e.g., ACK TP. For example, the electronic device 101 may determine a fetch interval of 2 ms to fetch TCP ACKs of four groups when the ACK TP of each group is 400 kbps. Further, as described above, the determination of the fetch number based on ACK TP is merely exemplary, and the electronic device 101 may also determine the fetch number based on, e.g., the TCP ACK size. For example, assuming the TCP ACK size is 40 bytes, a maximum of 2 ACKs per group may be transmittable per 2 ms, and accordingly the fetch number may be set to 2. As described above, the electronic device 101 may identify information 903 about a fetch interval time (e.g., 2 ms) and fetch number (number of ack) (e.g., 2) for any group. Meanwhile, the priority may be set to “default”, but there is no limitation on the method of setting priority. According to the method described above, the electronic device 101 may set a fetch interval time (e.g., 2 ms) and fetch number (number of ack) (e.g., 2) for each group, as in FIG. 9B. The priority may be set to “normal”, which is “default”, but there is no limitation on the method of setting priority. Meanwhile, in the embodiment of FIG. 9B, the same policy has been described for all groups, but this is exemplary and policies of two groups may be set at least partially differently. Meanwhile, the electronic device 101 may periodically (or based on event occurrence) identify TCP-related information (e.g., information for identifying a session and/or ACK TP) and/or network-related information (e.g., which may be MCS but there is no limitation), and may also identify at least some changes. The electronic device 101 may adjust at least some of the fetch number, fetch interval, and/or priority based on the changed information.

In certain example embodiments, the electronic device 101 may perform fetching of TCP ACKs based on a policy 905 as in FIG. 9B. For example, as in FIG. 9C, a post-processing module 930 may perform fetching from each of a plurality of TCP ACK groups 921, 922, 923, 924. The post-processing module 930 may fetch at least one TCP ACK from each of the groups 921, 922, 923, 924 based on, e.g., the policy 905. Accordingly, at least one fetched TCP ACK 931 may be identified. For example, in the policy 905, the fetch interval for each of the plurality of groups 921, 922, 923, 924 may be 2 ms, and the fetch number may be 2. The post-processing module 930 may fetch 2 TCP ACKs every 2 ms from each of the groups 921, 922, 923, 924 based on, e.g., the policy 905. For example, in the policy 905, the priority for each group 921, 922, 923, 924 may be the same as “normal”. The post-processing module 930 may fetch TCP ACKs from the groups 921, 922, 923, 924 based on a designated rule (e.g., which may be random selection or selection in order of designated identification numbers but there is no limitation) as the priorities for the groups 921, 922, 923, 924 are the same. In certain example embodiments, the post-processing module 930 may select one from among the at least one TCP ACK 931 fetched for each group and provide it to a queue 932. Accordingly, four TCP ACKs selected corresponding to each of the four groups 921, 922, 923, 924 may be stored in the queue 932. For example, the TCP ACK having the largest SN among the TCP ACKs fetched for each group may be selected and provided to the queue 932, but there is no limitation on the selection method. The TCP ACKs stored in the queue 932 may be sequentially provided to the L2 layer. As described above, four TCP ACKs may be provided to the L2 layer every 2 ms. In this case, if the size of one TCP ACK is 40 bytes, e.g., 40×4=160 bytes may be provided to the L2 layer in 2 ms. As described above, the fetch interval and/or fetch number may be set such that 160 bytes provided to the L2 layer is less than the UL capacity of the network, which is 175 bytes/2 ms.

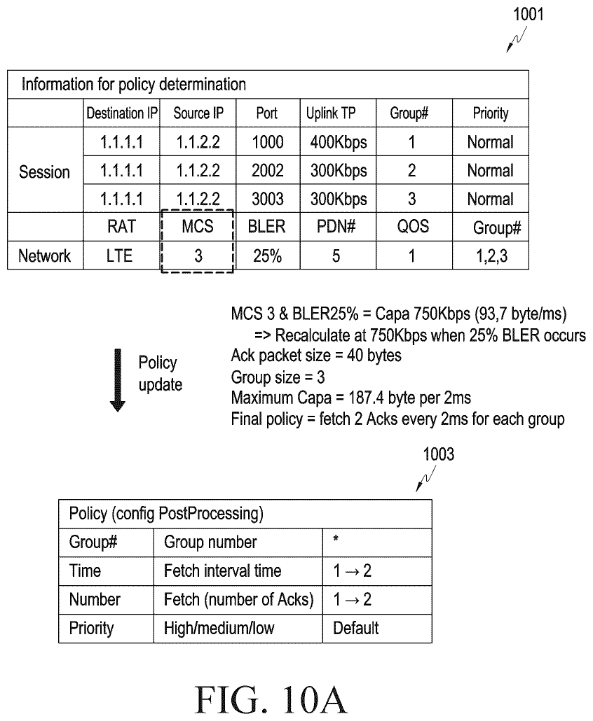

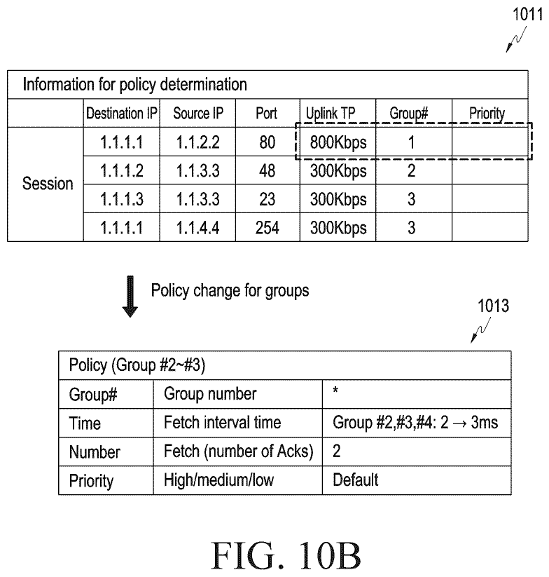

FIG. 10A is a view illustrating policy determination according to an embodiment.

In certain example embodiments, the electronic device 101 (e.g., the communication processor 320) may identify information 1001 for policy determination. The information 1001 for policy determination may include, e.g., TCP-related information and/or network-related information. In the embodiment of FIG. 10A, the information 901 may include address information (e.g., destination IP address (Dest. IP) and source IP address (Src.IP)) and port number (Port) corresponding to each of three groups (group #1, group #2, group #3). Meanwhile, in the information 1001 of FIG. 10A, even though the three groups (group #1, group #2, group #3) include the same address, the three groups (group #1, group #2, group #3) may be distinguished as the port numbers are different. Meanwhile, the three groups (group #1, group #2, group #3) including the same address is exemplary and may be at least partially different. The priority for the three groups (group #1, group #2, group #3) has been described as being the same as “normal,” but this is exemplary and may be at least partially different. The information 1001 may include ACK throughput (ACK TP). The ACK TP for each group (group #1, group #2, group #3) may be identified as 400 Kbps, 300 Kbps, and 300 Kbps. The three groups (group #1, group #2, group #3) may correspond to a RAT of “LTE” (or E-UTRA), an MCS of “3”, a “BLER of 25%”, PDN connection identification information of “5”, and a QoS of “1”.

In certain example embodiments, the electronic device 101 may identify an uplink capacity based on the MCS. For example, the electronic device 101 may identify an uplink capacity of “1 Mbps” based on the MCS of “3”. The electronic device 101 may identify the UL capacity as “1 Mbps”×0.75 (multiplying by 70% based on the BLER being 25%)=“750 Kbps=93.7 byte/ms” based on the BLER being 25%. The electronic device 101 may identify the packet size of a TCP ACK as, e.g., “40 bytes”. The electronic device 101 may identify 3×40 bytes=120 bytes by multiplying the total number of groups (e.g., which may be the number of sessions), which is 3, by “40 bytes”, which is the packet size of a TCP ACK. As described above, the electronic device 101 may identify that the uplink capacity is “93.7 byte/ms” and the product of the TCP ACK packet size and the number of groups is “120 bytes”. The electronic device 101 may determine the fetch interval such that, e.g., the product of the uplink capacity and the fetch interval (e.g., MAX capa) is greater than the product of the TCP ACK packet size and the number of groups. For example, the electronic device 101 may determine the fetch interval such that the product of “93.7 byte/ms” and the fetch interval is greater than “120 bytes”, and accordingly may determine the fetch interval as 2 ms. Accordingly, “187.4 bytes”, which is the product of “93.7 byte/ms” and the fetch interval “2 ms”, may be greater than “120 bytes”.

In certain example embodiments, the electronic device 101 may also identify a fetch number based on, e.g., ACK TP. The electronic device 101 may identify, e.g., that the sum of ACK TP of each group is 400+300+300=“1000 Kbps”. The electronic device 101 may determine the fetch number such that, e.g., the product of the fetch number and the uplink capacity of the network is greater than the sum of ACK TP. For example, the electronic device 101 may determine as the fetch number the minimum or a low value of the fetch number such that the product of the uplink capacity of the network, 750 kbps, and the fetch number is greater than the sum of ACK TP, “1000 Kbps”, and may determine the fetch number as “2”, for example. According to the above, the electronic device 101 may determine a policy 1003 corresponding to the information 1001, and the policy 1003 may include a fetch interval of “2 ms” and a fetch number of “2 ms”.

Meanwhile, if the BLER is 0%, the fetch interval may be determined as “1 ms” and the fetch number may be “1”. For example, when the BLER is 0%, since the UL capacity is 1000 kbps, it may be the same value as the sum of ACK TP, 1000 kbps, and accordingly the fetch number may be “1”. Further, the product of packet size and number of groups is 120 bytes, which may be greater than the UL capacity of 1000 kbps=125 bytes/ms, so the fetch interval may be “1 ms”. Accordingly, as the BLER among network-related information changes from “0%” to “25%”, the electronic device 101 may update the fetch number from 1 to 2 and update the fetch interval from 1 ms to 2 ms. As described above, the electronic device 101 may adaptively update the policy according to changes in the network communication environment.

FIG. 10B is a view illustrating policy determination according to an embodiment.

In certain example embodiments, the electronic device 101 (e.g., the communication processor 320) may identify information 1011 for policy determination. The information 1011 for policy determination may include, e.g., TCP-related information and/or network-related information. For example, let's assume that the electronic device 101 identifies the information 901 of FIG. 9A at a first time and then identifies the information 1011 of FIG. 10B at a second time. According to changes in TCP-related information and/or network-related information, the information identified by the electronic device 101 may also change from the information 901 to the information 1011. In the embodiment of FIG. 10B, the information 1011 may include address information (e.g., destination IP address (Dest. IP) and source IP address (Src.IP)) and port number (Port) corresponding to each of four groups (group #1, group #2, group #3, group #4). In the information 1011 of FIG. 10B, the IP addresses of the four groups (group #1, group #2, group #3, group #4) may be different. Meanwhile, the electronic device 101 may identify that the ACK TP corresponding to the first group (group #1) is 800 Kbps, and the ACK TP corresponding to the second group (group #2), the third group (group #3), and the fourth group (group #4) is 300 Kbps. For example, as ACK retransmission occurs in the PDN connection corresponding to the first group (group #1), the ACK TP may increase to 800 Kbps. The electronic device 101 may perform ACK duplication for ACK retransmission. The electronic device 101 may not perform ACK aggregation for ACKs for retransmission. Accordingly, the electronic device 101 may not perform ACK aggregation for the first group (group #1), which is a group performing ACK retransmission (or a group where ACK duplication is performed), and accordingly a policy for fetching may not be determined for the first group (group #1), or the existing policy may not be applied. Or, the existing policy may be maintained for the first group (group #1). The electronic device 101 may update the policy 1013 for the second group (group #2), the third group (group #3), and the fourth group (group #4) (e.g., update the fetch interval from the existing “2 ms” to “3 ms”). As such, the electronic device 101 may be configured to update policies for groups where ACK retransmission has not occurred.

Table 1 is an example of the aggregation ratio identified when applying the embodiments of the disclosure. Here, the aggregation ratio may be the ratio of the number of discarded ACKs to the ACK count by the AP, and may also be named the discard ratio.

TABLE 1

| | Downlink | ACK | ACK | | |
|---|---|---|---|---|---|
| Experiment | packet | count | count | Downlink | Aggregation |
| order | count | by AP | by CP | throughput | ratio |
| 1 | 18,066 | 14,519 | 7,609 | 748 | 51 |
| 2 | 18,129 | 14,277 | 7,589 | 745 | 52 |
| 3 | 17,867 | 15,544 | 7,517 | 747 | 48 |

As illustrated in Table 1, the aggregation ratio may be identified as about 50%, and accordingly it may be identified that the number of ACKs transmitted to the network is decreased. Further, it may also be identified that the aggregation ratio is also adaptively changed based on changes in TCP-related information and/or network-related information. In certain example embodiments, an electronic device 101 may include at least one communication processor 320 and at least one application processor 310. The at least one communication processor 320 may be configured to obtain a plurality of TCP ACKs generated based on a network stack executed in the at least one application processor 310. The at least one communication processor 320 may be configured to classify and store the plurality of TCP ACKs by a plurality of groups in at least one buffer associated with the at least one communication processor 320. The at least one communication processor 320 may be configured to fetch at least one TCP ACK from each of the plurality of groups based on policies set corresponding to each of the plurality of groups. The at least one communication processor 320 may be configured to transmit at least a portion of each of the fetched at least one TCP ACK.

In certain example embodiments, the at least one communication processor 320 may be further configured to determine the policies corresponding to each of the plurality of groups based on TCP-related information and/or network-related information.

In certain example embodiments, the at least one communication processor 320 may be configured to, as at least a portion of determining the policies corresponding to each of the plurality of groups based on the TCP-related information and/or the network-related information, determine fetch intervals corresponding to each of the plurality of groups as at least a portion of the policies based on at least a portion of the TCP-related information and/or the network-related information.

In certain example embodiments, the at least one communication processor 320 may be configured to, as at least a portion of determining the fetch intervals corresponding to each of the plurality of groups based on at least a portion of the TCP-related information and/or the network-related information, identify an uplink capacity identified based on an MCS included in the network-related information. In certain example embodiments, the at least one communication processor 320 may be configured to, as at least a portion of determining the fetch intervals corresponding to each of the plurality of groups based on at least a portion of the TCP-related information and/or the network-related information, determine the fetch intervals corresponding to each of the plurality of groups based on the uplink capacity.

In certain example embodiments, the at least one communication processor 320 may be configured to, as at least a portion of determining the fetch intervals corresponding to each of the plurality of groups based on the uplink capacity, identify sizes of TCP ACKs associated with each of the plurality of groups. In certain example embodiments, the at least one communication processor 320 may be configured to, as at least a portion of determining the fetch intervals corresponding to each of the plurality of groups based on the uplink capacity, determine each of the fetch intervals based on the sizes and the uplink capacity.

In certain example embodiments, the at least one communication processor 320 may be configured to, as at least a portion of determining the fetch intervals corresponding to each of the plurality of groups based on the uplink capacity, identify an ACK throughput between the at least one application processor 310 and the at least one communication processor 320 included in the TCP-related information. In certain example embodiments, the at least one communication processor 320 may be configured to, as at least a portion of determining the fetch intervals corresponding to each of the plurality of groups based on the uplink capacity, determine each of the fetch intervals based on the ACK throughput and the uplink capacity.

In certain example embodiments, the at least one communication processor 320 may be configured to, as at least a portion of determining the fetch intervals corresponding to each of the plurality of groups based on the uplink capacity, determine the fetch intervals corresponding to each of the plurality of groups based on the uplink capacity and a BLER included in the network-related information.

In certain example embodiments, the at least one communication processor 320 may be configured to, as at least a portion of determining the policies corresponding to each of the plurality of groups based on the TCP-related information and/or the network-related information, determine fetch numbers corresponding to each of the plurality of groups as at least a portion of the policies based on at least a portion of the TCP-related information and/or the network-related information.

In certain example embodiments, the at least one communication processor 320 may be configured to, as at least a portion of determining the fetch numbers corresponding to each of the plurality of groups based on at least a portion of the TCP-related information and/or the network-related information, identify an uplink capacity identified based on an MCS included in the network-related information. In certain example embodiments, the at least one communication processor 320 may be configured to, as at least a portion of determining the fetch numbers corresponding to each of the plurality of groups based on at least a portion of the TCP-related information and/or the network-related information, determine the fetch numbers corresponding to each of the plurality of groups based on the uplink capacity.

In certain example embodiments, the at least one communication processor 320 may be configured to, as at least a portion of determining the fetch numbers corresponding to each of the plurality of groups based on the uplink capacity, identify an ACK throughput between the at least one application processor 310 and the at least one communication processor 320 included in the TCP-related information. In certain example embodiments, the at least one communication processor 320 may be configured to, as at least a portion of determining the fetch numbers corresponding to each of the plurality of groups based on the uplink capacity, determine each of the fetch numbers based on the ACK throughput and the uplink capacity. “Based on” as used herein covers based at least on.

In certain example embodiments, the at least one communication processor 320 may be configured to, as at least a portion of determining the fetch numbers corresponding to each of the plurality of groups based on the uplink capacity, identify sizes of TCP ACKs associated with each of the plurality of groups. In certain example embodiments, the at least one communication processor 320 may be configured to, as at least a portion of determining the fetch numbers corresponding to each of the plurality of groups based on the uplink capacity, determine each of the fetch numbers based on the sizes and the uplink capacity.

In certain example embodiments, the at least one communication processor 320 may be configured to, as at least a portion of determining the fetch numbers corresponding to each of the plurality of groups based on the uplink capacity, determine the fetch numbers corresponding to each of the plurality of groups based on the uplink capacity and a BLER included in the network-related information.

In certain example embodiments, the at least one communication processor 320 may be configured to identify a change in at least a portion of the TCP-related information and/or the network-related information. In certain example embodiments, the at least one communication processor 320 may be further configured to update at least a portion of the policies based on the identified change.

In certain example embodiments, the at least one communication processor 320 may be configured to, as at least a portion of updating at least a portion of the policies based on the identified change, update at least one policy corresponding to at least a portion of at least one group of the plurality of groups in which ACK retransmission has not occurred.

In certain example embodiments, the plurality of groups may be distinguished based on an IP address, a port number, and/or network interface identification information.

In certain example embodiments, the at least one communication processor 320 may be configured to, as at least a portion of transmitting at least a portion of each of the fetched at least one TCP ACK, transmit a TCP ACK having a largest sequence number among at least one first TCP ACK fetched from a first group of the plurality of groups as a TCP ACK corresponding to the first group.

In certain example embodiments, in a storage medium storing at least one computer-readable instruction, the at least one instruction may, when executed by at least one processor of an electronic device 101, cause the electronic device 101 to perform at least one operation. The at least one operation may include obtaining a plurality of TCP ACKs. The at least one operation may include classifying and storing the plurality of TCP ACKs by a plurality of groups. The at least one operation may include fetching at least one TCP ACK from each of the plurality of groups based on policies set corresponding to each of the plurality of groups. The at least one operation may include transmitting at least a portion of each of the fetched at least one TCP ACK.

In certain example embodiments, the at least one operation may include determining the policies corresponding to each of the plurality of groups based on TCP-related information and/or network-related information.

In certain example embodiments, determining the policies corresponding to each of the plurality of groups based on the TCP-related information and/or the network-related information may determine fetch intervals corresponding to each of the plurality of groups as at least a portion of the policies based on at least a portion of the TCP-related information and/or the network-related information.

In certain example embodiments, determining the fetch intervals corresponding to each of the plurality of groups based on at least a portion of the TCP-related information and/or the network-related information may include identifying an uplink capacity identified based on an MCS included in the network-related information. In certain example embodiments, determining the fetch intervals corresponding to each of the plurality of groups based on at least a portion of the TCP-related information and/or the network-related information may include determining the fetch intervals corresponding to each of the plurality of groups based on the uplink capacity.

In certain example embodiments, determining the fetch intervals corresponding to each of the plurality of groups based on the uplink capacity may include identifying sizes of TCP ACKs associated with each of the plurality of groups.

In certain example embodiments, determining the fetch intervals corresponding to each of the plurality of groups based on the uplink capacity may include determining each of the fetch intervals based on the sizes and the uplink capacity.

In certain example embodiments, determining the fetch intervals corresponding to each of the plurality of groups based on the uplink capacity may include identifying an ACK throughput between the at least one application processor 310 and the at least one communication processor 320 included in the TCP-related information. In certain example embodiments, determining the fetch intervals corresponding to each of the plurality of groups based on the uplink capacity may include determining each of the fetch intervals based on the ACK throughput and the uplink capacity.

In certain example embodiments, determining the fetch intervals corresponding to each of the plurality of groups based on the uplink capacity may determine the fetch intervals corresponding to each of the plurality of groups based on the uplink capacity and a BLER included in the network-related information.

In certain example embodiments, determining the policies corresponding to each of the plurality of groups based on the TCP-related information and/or the network-related information may determine fetch numbers corresponding to each of the plurality of groups as at least a portion of the policies based on at least a portion of the TCP-related information and/or the network-related information.

In certain example embodiments, determining the fetch numbers corresponding to each of the plurality of groups based on at least a portion of the TCP-related information and/or the network-related information may include identifying an uplink capacity identified based on an MCS included in the network-related information. In certain example embodiments, determining the fetch numbers corresponding to each of the plurality of groups based on at least a portion of the TCP-related information and/or the network-related information may include determining the fetch numbers corresponding to each of the plurality of groups based on the uplink capacity.

In certain example embodiments, determining the fetch numbers corresponding to each of the plurality of groups based on the uplink capacity may include identifying an ACK throughput between the at least one application processor 310 and the at least one communication processor 320 included in the TCP-related information. In certain example embodiments, determining the fetch numbers corresponding to each of the plurality of groups based on the uplink capacity may include determining each of the fetch numbers based on the ACK throughput and the uplink capacity.

In certain example embodiments, determining the fetch numbers corresponding to each of the plurality of groups based on the uplink capacity may include identifying sizes of TCP ACKs associated with each of the plurality of groups. In certain example embodiments, determining the fetch numbers corresponding to each of the plurality of groups based on the uplink capacity may include determining each of the fetch numbers based on the sizes and the uplink capacity.

In certain example embodiments, determining the fetch numbers corresponding to each of the plurality of groups based on the uplink capacity may determine the fetch numbers corresponding to each of the plurality of groups based on the uplink capacity and a BLER included in the network-related information.

In certain example embodiments, the at least one operation may include identifying a change in at least a portion of the TCP-related information and/or the network-related information. In certain example embodiments, the at least one operation may include updating at least a portion of the policies based on the identified change.

In certain example embodiments, updating at least a portion of the policies based on the identified change may update at least one policy corresponding to at least a portion of at least one group of the plurality of groups in which ACK retransmission has not occurred.

In certain example embodiments, the plurality of groups may be distinguished based on an IP address, a port number, and/or network interface identification information.

In certain example embodiments, transmitting at least a portion of each of the fetched at least one TCP ACK may transmit a TCP ACK having a largest sequence number among at least one first TCP ACK fetched from a first group of the plurality of groups as a TCP ACK corresponding to the first group.

In certain example embodiments, an operation method of an electronic device 101 may include obtaining a plurality of TCP ACKs. The operation method of the electronic device 101 may include classifying and storing the plurality of TCP ACKs by a plurality of groups. The operation method of the electronic device 101 may include fetching at least one TCP ACK from each of the plurality of groups based on policies set corresponding to each of the plurality of groups. The operation method of the electronic device 101 may include transmitting at least a portion of each of the fetched at least one TCP ACK.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, In certain example embodiments, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In certain example embodiments, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

In certain example embodiments, each component (e.g., a module or a program) of the above-described components may include a single entity or multiple entities. Some of the plurality of entities may be separately disposed in different components. In certain example embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
at least one communication processor comprising processing circuitry; and
at least one application processor comprising processing circuitry, wherein the at least one communication processor is configured to:
obtain a plurality of TCP ACKs generated based on a network stack executed in the at least one application processor;
classify and store the plurality of TCP ACKs by a plurality of groups in at least one buffer associated with the at least one communication processor;
fetch at least one TCP ACK from each of the plurality of groups based on policies set corresponding to each of the plurality of groups; and
control to transmit at least a portion of each of the fetched at least one TCP ACK.

2. The electronic device of claim 1, wherein the at least one communication processor is configured to determine the policies corresponding to each of the plurality of groups based on TCP-related information and/or network-related information.

3. The electronic device of claim 2, wherein the at least one communication processor is configured to, as at least a portion of determining the policies corresponding to each of the plurality of groups based on the TCP-related information and/or the network-related information, determine fetch intervals corresponding to each of the plurality of groups as at least a portion of the policies based on at least a portion of the TCP-related information and/or the network-related information.

4. The electronic device of claim 2, wherein the at least one communication processor is configured to, as at least a portion of determining the fetch intervals corresponding to each of the plurality of groups based on at least a portion of the TCP-related information and/or the network-related information,
identify an uplink capacity identified based on an MCS included in the network-related information; and
determine the fetch intervals corresponding to each of the plurality of groups based on the uplink capacity.

5. The electronic device of claim 4, wherein the at least one communication processor is configured to, as at least a portion of determining the fetch intervals corresponding to each of the plurality of groups based on the uplink capacity,
identify sizes of TCP ACKs associated with each of the plurality of groups; and
determine each of the fetch intervals based on the sizes and the uplink capacity.

6. The electronic device of claim 4, wherein the at least one communication processor is configured to, as at least a portion of determining the fetch intervals corresponding to each of the plurality of groups based on the uplink capacity,
identify an ACK throughput between the at least one application processor and the at least one communication processor included in the TCP-related information; and
determine each of the fetch intervals based on the ACK throughput and the uplink capacity.

7. The electronic device of claim 4, wherein the at least one communication processor is configured to, as at least a portion of determining the fetch intervals corresponding to each of the plurality of groups based on the uplink capacity, determine the fetch intervals corresponding to each of the plurality of groups based on the uplink capacity and a BLER included in the network-related information.

8. The electronic device of claim 2, wherein the at least one communication processor is configured to, as at least a portion of determining the policies corresponding to each of the plurality of groups based on the TCP-related information and/or the network-related information, determine fetch numbers corresponding to each of the plurality of groups as at least a portion of the policies based on at least a portion of the TCP-related information and/or the network-related information.

9. The electronic device of claim 2, wherein the at least one communication processor is configured to, as at least a portion of determining the fetch numbers corresponding to each of the plurality of groups based on at least a portion of the TCP-related information and/or the network-related information,
identify an uplink capacity identified based on an MCS included in the network-related information; and
determine the fetch numbers corresponding to each of the plurality of groups based on the uplink capacity.

10. The electronic device of claim 9, wherein the at least one communication processor is configured to, as at least a portion of determining the fetch numbers corresponding to each of the plurality of groups based on the uplink capacity,
identify an ACK throughput between the at least one application processor and the at least one communication processor included in the TCP-related information; and
determine each of the fetch numbers based on the ACK throughput and the uplink capacity.

11. The electronic device of claim 9, wherein the at least one communication processor is configured to, as at least a portion of determining the fetch numbers corresponding to each of the plurality of groups based on the uplink capacity,
identify sizes of TCP ACKs associated with each of the plurality of groups; and
determine each of the fetch numbers based on the sizes and the uplink capacity.

12. The electronic device of claim 9, wherein the at least one communication processor is configured to, as at least a portion of determining the fetch numbers corresponding to each of the plurality of groups based on the uplink capacity,
determine the fetch numbers corresponding to each of the plurality of groups based on the uplink capacity and a BLER included in the network-related information.

13. The electronic device of claim 1, wherein the plurality of groups are distinguished based on an IP address, a port number, and/or network interface identification information.

14. The electronic device of claim 1, wherein the at least one communication processor is configured to, as at least a portion of controlling for transmitting at least a portion of each of the fetched at least one TCP ACK, control to transmit a TCP ACK having a largest sequence number among at least one first TCP ACK fetched from a first group of the plurality of groups as a TCP ACK corresponding to the first group.

15. A storage medium storing at least one computer-readable instruction, wherein the at least one instruction, when executed individually and/or collectively by at least one processor of an electronic device, causes the electronic device to perform at least one operation comprising:
obtaining a plurality of TCP ACKs;
classifying and storing the plurality of TCP ACKs by a plurality of groups;
fetching at least one TCP ACK from each of the plurality of groups based on policies set corresponding to each of the plurality of groups; and
transmitting at least a portion of each of the fetched at least one TCP ACK.

16. A method performed by an electronic device comprising at least one communication processor comprising processing circuitry, and at least one application processor comprising processing circuitry, the method comprising:
obtaining a plurality of TCP ACKs generated based on a network stack executed in the at least one application processor;
classifying and storing the plurality of TCP ACKs by a plurality of groups;
fetching at least one TCP ACK from each of the plurality of groups based on policies set corresponding to each of the plurality of groups; and
transmitting at least a portion of each of the fetched at least one TCP ACK.

17. The method of claim 16, further comprising determining the policies corresponding to each of the plurality of groups based on TCP-related information and/or network-related information.

18. The method of claim 17, wherein determining the policies corresponding to each of the plurality of groups based on the TCP-related information and/or the network-related information comprises:
determining fetch intervals corresponding to each of the plurality of groups as at least a portion of the policies based on at least a portion of the TCP-related information and/or the network-related information.

19. The method of claim 17, wherein determining the fetch intervals corresponding to each of the plurality of groups based on at least a portion of the TCP-related information and/or the network-related information comprises:
identifying an uplink capacity identified based on an MCS included in the network-related information; and
determining the fetch intervals corresponding to each of the plurality of groups based on the uplink capacity.

20. The method of claim 19, wherein determining the fetch intervals corresponding to each of the plurality of groups based on the uplink capacity comprises:
identifying sizes of TCP ACKs associated with each of the plurality of groups; and
determining each of the fetch intervals based on the sizes and the uplink capacity.
